(19) United States
(12) Patent Application Publication
(10) Pub. No.: US 2010/0066540 A1
(43) Pub. Date: Mar. 18, 2010

(54) System, method, and software for automated detection of predictive events

(76) Inventors: Daniel Theobald, Somerville, MA (US); Steven Niemczyk, Bethesda, MD (US)

Correspondence Address: Vecna, Inc., 38 Cambridgepark Drive, Cambridge, MA, 02140, US

(21) Appl. No.: 12/583,978

(22) Filed: Aug. 28, 2009

Related U.S. Application Data
(63) Continuation of application No. 11/284,094, filed on Nov. 22, 2005, now abandoned.

(51) Int. Cl. G08B 23/00; G06F 19/00

(52) U.S. Cl. 340/573.1; 702/19

(57) ABSTRACT

A system for the automatic detection and communication of detection of nosocomial infection and/or antimicrobial resistance events in a health care environment includes an input unit that receives nosocomial infection and/or antimicrobial resistance related data, an an event detection machine, and a knowledge discovery unit. The event detection machine sorts and analyzes the nosocomial infection and/or antimicrobial resistance related data to automatically generate alerts for isolates that violate control parameters indicative of a nosocomial infection and/or antimicrobial resistance event and communicates the alert to a user.

### CROSS-REFERENCE TO RELATED PATENT APPLICATIONS

This application claims the benefit of priority under 35 U.S.C. §119(e) of provisional application No. 60/629,891, filed on Nov. 23, 2004, the disclosure of which is incorporated herein in its entirety.

### STATEMENT REGARDING FEDERALLY FUNDED RESEARCH

This invention was made, at least in part, with U.S. government support under a grant awarded by NM. The U.S. government may have certain rights in parts of the invention disclosed herein.

### FIELD OF THE INVENTION

In a general aspect, the present invention relates to an automated system and method for detecting predictive events applicable in many fields including health care, homeland security, marketing, technology, process, or financial monitoring, and/or economics. In one aspect, the automated system and method may be applied to the field of health care, specifically, to detect hospital-acquired infections and antimicrobial resistance. The present invention further relates to systems and techniques for identifying and resolving disease outbreaks at an early stage and monitoring and limiting antimicrobial resistance and antibiotic misuse at an early juncture.

### BACKGROUND OF THE INVENTION

In a general aspect, hospital-acquired infections and antimicrobial resistance are serious problems in modern healthcare, resulting in substantial morbidity, mortality, and waste of medical resources. Current attempts to control these infections are severely limited by inadequate informational support and antiquated techniques for timely detection. The data necessary to detect these problems often already exists in hospital databases, yet it is not being processed or presented to infection control practitioners (“ICPs”) in a useful manner. Current infection control programs are often incapable of identifying disease outbreaks and changes in resistance to antibiotics at early stages when opportunities for effective intervention exist.

Every year billions of dollars and many lives are lost to such hospital-acquired or nosocomial infections. Estimates from the Centers for Disease Control and Prevention (“CDC”) from 1992 suggest that 2,000,000 (some estimate as many as 5,000,000) patients acquire a nosocomial infection each year, at a total cost of more than $4.5 billion. In 19,000 instances, these infections were directly responsible for patient death, and in 58,000 instances they were indirectly responsible for patient death. Centers for Disease Control and Prevention, 89(8) MORB. MORAL. WEEKLY REP 149-53 (2000); Centers for Disease Control and Prevention, 41 MORB. MORAL. WEEKLY REP. 783-87 (1992); MARTONE ET AL., HOSPITAL INFECTIONS 577-96 (1992); Haley et al., 121 AM. J. EPIDEMIOL 159-67 (1985); Haley et al., 121 AM. J. EPIDEMIOL 182-205 (1985). Nosocomial infections are the second most common adverse event of hospitalization, and antibiotics are the most common cause of adverse drug events. Brennan et al., 324(6) NEW ENGLAND J. MED. 370-76 (1991); Leape et al., 324(6) NEW ENGLAND J. MED. 377-84 (1991).

Careful studies have indicated that approximately one-third of all nosocomial infections can be avoided by appropriate infection control practices, including surveillance. Centers for Disease Control and Prevention, 89(8) MORB. MORAL. WEEKLY REP 149-53 (2000); Haley et al., 121 AM. J. EPIDEMIOL 182-205 (1985). Other studies have documented that a 6% reduction in nosocomial infection rates can finance an entire infection control program. HALEY, MANAGING HOSPITAL INFECTION CONTROL FOR COST EFFECTIVENESS (American Hospital Association, 1986). These figures presuppose relatively simple infection control practices; efficacy would likely increase with improved informational support.

In most instances, nosocomial infections are endemic, related to compromised hosts or exposure to invasive or risky procedures or devices. Depending on setting and type of infection, however, 2% (all nosocomial infections in a community hospital) to 20% (blood stream infections in intensive care units) or more (60% of methicillin-resistant S. aureus (MRSA) infections in German ICUs) of nosocomial infections are epidemic. Gastmeier et al., Nosocomial MRSA infections in intensive care units in Germany: Do endemic or epidemic infections dominate? Abstract 0034, SHEA 11th Annual Conference (Apr. 1-3, 2001); Wenzel et al., 4(5) INFECT. CONTROL 371-75 (1983); Stamm et al., 70 AM. J. MED. 393-97 (1981). Even serious outbreaks can escape detection until late in their course, while minor clusters are often undetected. The proportion of preventable epidemic infections is likely to be higher because many endemic infections are unavoidable, whereas epidemic infections are largely preventable. A simple estimate of epidemic nosocomial infection burden is thus 40,000 (2% of 2,000,000) to perhaps 500,000 (10% of 5,000,000) annually in the US. Most hospitals in the US will have at least one such outbreak per year, while large referral hospitals may have several. Haley et al., 6(6) INFECT. CONTROL 233-36 (1985). The significance of outbreaks is likely greater than the actual number of patients involved, as their presence and resolution affects hospital public relations, patient confidence, and infection control influence in healthcare facilities.

Moreover, nosocomial clusters can be difficult to detect. A review of CDC investigations of hospital outbreaks from 1956 to 1979 demonstrated that many epidemics are detected late in their course, representing avoidable suffering and waste. Stamm et al., 70 AM. J. MED. 393-97 (1981). A nation-wide outbreak of an Enterobacter bloodstream infection in 1976 was missed for over four months, with serious ramifications, in spite of manual surveillance by highly trained CDC epidemiologists. Goldmann et al., 108(3) AM. J. EPIDEMIOL. 207-13 (1978). While there are increasing options for computerized surveillance, most current methods for outbreak detection are effective only at a significant time after the actual events. Brossette et al., 39 METHOD INFORM. MED. 303-10 (2000); Stem et al., 122(1) EPIDEMIOL. INFECT. 103-10 (1999); Hutwagner et al., 3 EMERG. INF. DIS. 395-400 (1997); Ngo et al., 143 AM. J. EPIDEMIOL. 637-47 (1996); O'Brien, 2 TRENDS IN MICROBIOL. 366-71 (1994). Techniques are often poorly automated, and few sophisticated cluster detection techniques have been employed in infection control and antimicrobial resistance surveillance. Jacquez et al., 17(5) INFECT. CONTROL HOSP. EPIDEMIOL. 319-27 (1996); Jacquez et al., 17(6) INFECT. CONTROL HOSP. EPIDEMIOL. 385-97 (1996); Koontz, 15 (Suppl. 2) MICROBIOL. INFECT. DIS. 3-10 (1992); Birnbaum, 5(7) INFECT. CONTROL 332-38 (1984); Childress et al., 2(3) INFECT. CONTROL 247-49 (1981).

Intimately related to hospital infections and potentially even more significant is the looming specter of antibiotic resistance. Compelling evidence is accruing that poor infection control and inappropriate antibiotic usage in hospitals, particularly intensive care units (“ICU”), are responsible for the rise in antibiotic resistance. Data from the CDC demonstrate that the prevalence of methicillin resistance in S. aureus is continually increasing, reaching 53% for 1999 in the ICUs participating in the CDC's National Nosocomial Infection Surveillance (“NNIS”) system. Rates of vancomycin resistance in Enterococci have reached 25% in the same populations. Centers for Disease Control and Prevention, Technical Report: National Nosocomial Infection Surveillance System: Semi-annual report (Centers for Disease Control and Prevention (June 2000)). Methicillin-resistant S. aureus (“MRSA”) is gradually acquiring resistance to vancomycin, so-called Vancomycin-Intermediate S. aureus (“VISA”). Smith et al., 340 NEW ENGLAND J. MED. 493-501 (1999). This global threat has compelled public health agencies to issue urgent calls for action. Centers for Disease Control and Prevention, A Public Health Action Plan to Combat Antimicrobial Resistance (Centers for Disease Control and Prevention (2001)); World Health Organization, Technical Report: Containing Antimicrobial Resistance: Review of the Literature and Report of a WHO Workshop on the Development of a Global Strategy for the Containment of Antimicrobial Resistance. (World Health Organization (February 1999)). While the resolution of antibiotic resistance is difficult and complex, evidence is accumulating that data-driven interventions to change antibiotic prescribing practice have the capacity to decrease anti-microbial resistance. Society for Healthcare Epidemiology of America, 25 CLIN. INFECT. DIS. 584-99 (1997); Goldmann et al., 275 JAMA 234-40 (1996). Nevertheless, whatever mechanisms are evaluated and implemented, they will not be effective in the absence of reliable, timely data. Indeed, data-drive interventions, informed by accurate, real-time date, are critical to reducing resistance and infection rates.

### SUMMARY OF THE INVENTION

In certain embodiments, a system for the automatic detection and communication of detection of nosocomial infection and/or antimicrobial resistance events in a health care environment is provided which includes: an input unit that receives nosocomial infection and/or antimicrobial resistance related data; an event detection machine; a knowledge discovery unit; and a user interface; wherein the event detection machine sorts and analyzes the nosocomial infection and/or antimicrobial resistance related data to automatically generate alerts for isolates that violate control parameters indicative of a nosocomial infection and/or antimicrobial resistance event; and wherein the user interface communicates the alerts to a user.

In certain embodiments, the received nosocomial infection and/or microbial resistance related data is stored in a persistence database which is used by the event detection machine.

In certain embodiments, the event detection machine comprises: a plurality of filter banks that filter the received nosocomial infection and/or antimicrobial resistance related data based on the control parameters; a plurality of signal generators that work with the output the filter bank in encoding a data signal with attribute associations based on the control parameters; a plurality of signal analysis modules which detect nosocomial infection and/or antimicrobial resistance events in the data signal; and a plurality of outputs displaying the results of the event detection.

On certain embodiments, the plurality of signal analysis modules comprise implementations of simple control charts, event-interval analysis, moving average analysis, and/or binary cumulative sum analysis.

In certain embodiments, the plurality of signal analysis modules are configured by the knowledge discovery unit that uses evolutionary algorithms to automatically program the event detection machine.

In certain embodiments, a method of automatically detecting nosocomial infection and/or microbial resistance events in a healthcare environment is provided which comprises the steps of: receiving a nosocomial infection and/or antimicrobial resistance related data; developing an event detection machine that automatically sorts and analyzes the nosocomial infection and/or antimicrobial related data and automatically generates an alert when an isolate violates control parameters indicative of a nosocomial infection and/or microbial resistance; and communicating the generated alert automatically to a user.

In certain embodiments, a computer readable medium having program code recorded thereon that, when executed on a computing system, causes the performance of the steps comprising: receiving a nosocomial infection and/or antimicrobial resistance related data; developing an event detection machine that automatically sorts and analyzes the nosocomial infection and/or antimicrobial related data and automatically generates an alert when an isolate violates control parameters indicative of a nosocomial infection and/or microbial resistance; and communicating the generated alert automatically to a user.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 provides one embodiment of the system architecture of the present invention.

FIG. 2 provides an example of a Exponentially-Weighted Moving Average G-Chart (“EWMAGC”).

FIG. 3 provides an example of binary cumulative sum (“CUSUM”) analysis.

FIG. 4 illustrates an example of an outbreak detection event detection machine (“EDM”).

FIG. 5 provides an example of EDM Crossover using Evolutionary Algorithms (“EA”).

FIG. 6 is an exemplary networked computing system that can be used implement parts of the present invention.

### DETAILED DESCRIPTION OF THE INVENTION

It is understood that the present invention is not limited to the particular system components, analysis techniques, etc. described herein, as these may vary. It is also to be understood that the terminology used herein is used for the purpose of describing particular embodiments only, and is not intended to limit the scope of the present invention. It must be noted that as used herein and in the appended embodiments, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, system components, and materials are described, although any methods and materials similar or equivalent to those described herein can be used in the practice or testing of the present invention. All references cited herein are incorporated by reference herein in their entirety.

All publications and patents mentioned herein are incorporated herein by reference for the purpose of describing and disclosing, for example, the system components and methods that are described in the publications, which might be used in connection with the presently described invention. The publications discussed herein are provided solely for their disclosure prior to the filing date of the present application. Nothing herein is to be construed as an admission that the inventors are not entitled to antedate such disclosure by virtue of prior invention or for any other reason.

In certain embodiments, the present invention addresses some of the significant problems discussed earlier herein. Specifically, in certain embodiments, the present invention provides a highly advanced infection surveillance system that enables health care facilities to identify and resolve disease outbreaks at an early stage, and monitor and limit antimicrobial resistance and antibiotic misuse at an early juncture. As a result, health care facilities can lower morbidity and mortality rates and economize scarce medical resources. Furthermore, in light of recent tragic events, the additional application of this technology to public health surveillance for possible terrorist initiated biological or chemical related outbreaks will be of enormous significance. There is tremendous potential for direct cost savings to hospitals. Even more significant are the indirect benefits such as improved patient care, increased patient confidence, and reduced vulnerability to litigation.

In certain embodiments, the present invention provides for the analysis of clinical microbiology data as a digital signal in real-time, providing earlier outbreak notification and more complete and accurate analysis of antimicrobial resistance trends. In fact, in certain embodiments, the present invention can replicate domain expert analysis in real-time. As shown herein, the certain embodiments detected every outbreak which had been previously identified by domain experts. It also identified additional events that had not been detected previously. Certain embodiments significantly increase the efficacy of infection control interventions by providing rapid analysis and timely alerts. Indeed, certain embodiments allow ICPs to focus their energy on improving the quality of care rather than performing inefficient manual data analysis.

More specifically, in certain embodiments, the present invention provides a common infrastructure for functional modules that can be plugged in and work together. Such modules include, but are not limited to, adverse event capture via the world wide web or other similar public or private network or combination thereof; microbiology lab results capture via interfacing to a hospital's IT systems; event tracking, root cause analysis, and risk/benefit analysis; statistical process control monitoring and statistical analysis; data sharing among different institutions and regional/national departments; advanced detection of outbreaks in any signal or combination of signals via analytic techniques including artificial-intelligence based analysis; process improvement tools such as project management, time-tracking, task and action management, calendar, etc.; and electronic survey creation, distribution and result analysis.

In this regard, in certain embodiments, the present invention allows ICPs to set up data to be viewed and monitored for infectious diseases including hospital-acquired infections, receive automated alert notifications in case of outbreaks, and prepare and print a variety of infection control reports. Hospital staff can enter adverse events as they are observed on the floor using a simple, web-based interface on a device such as a PDA, laptop computer, or a desktop computer.

More specifically, ICPs can track and perform root cause analysis of adverse events, proposed solutions, and create tasks that are automatically assigned to specified recipients. Adverse events may be tracked to completion using, for example, calendar alerts and notifications on due dates. ICPs may set up monitors to receive automated alert notifications for unusually high occurrences of particular events, and perform graphical and statistical analysis of occurrence of adverse events. In addition, patient safety reports may be generated as well as cost/benefit matrices to decide on what adverse events are more important than others and address them first.

In addition, ICPs can analyze adverse events including infection control events over time to identify trends. ICPs can also track sentinel events through the root cause analysis and improvement plan, and compare the hospital's performance with the national average and other hospitals with which statistics and data are being shared.

Epidemiologists can monitor infectious and hospital-acquired diseases and discover trends in antibiotic resistance changes. Microbiologists can predict shifts in antibiotic resistance to decide on which antibiotics to dispense to treat certain ailments. They can also set up monitors and data views for specific organisms of interest, and analyze the effectiveness of dispensed antibiotics given a patient's history of microbiology results and overall statistics of bacterial occurrence.

Using the present invention, health care administrators can identify relationships between hospital-acquired infections and finances, view snapshots of safety level and status of health care acquired infections, and create electronic surveys, distribute them, and view results online.

I. System Architecture and User Interface

A. System Architecture

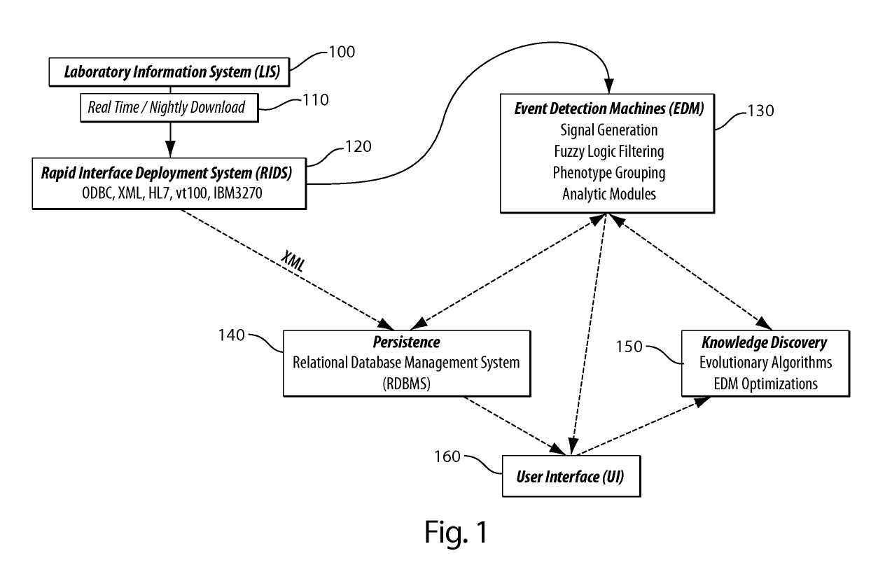

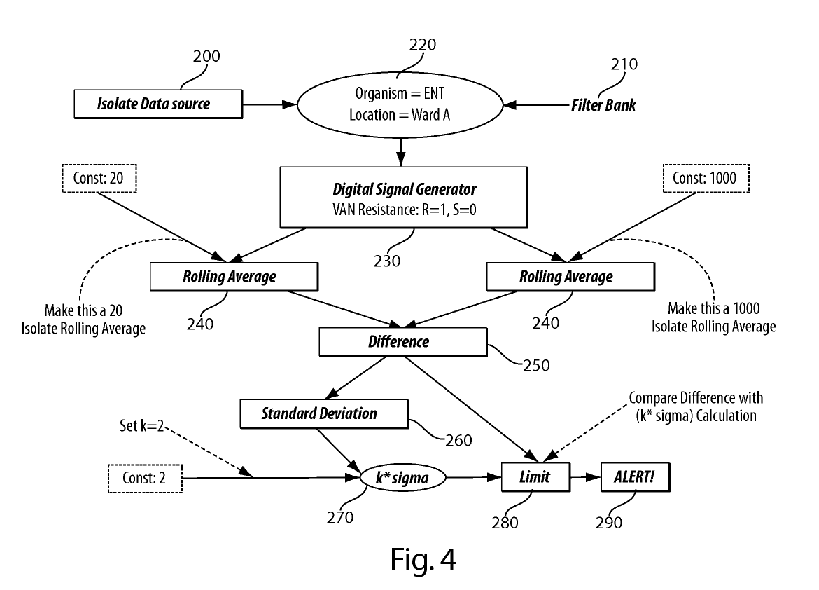

In certain embodiments of the present invention, the system architecture to implement the present invention comprises a three-tier web-based system. As shown in FIG. 1, data is transferred from the information management systems of various hospitals and/or treatment facilities data in a HIPAA-compliant manner which preserves the privacy of the patient data. It should be recognized that FIG. 1 is exemplary only. One skilled in the art would recognize various modifications and alternatives all of which are ton be considered to be a part of the present invention. In FIG. 1 (as well as in FIG. 4), each of the boxes could represent computing units (with processing and data store capabilities) while each of the arrows could represent network connections on which data and control could be transmitted. In FIG. 1, the data stored in a Laboratory Information System 100 or other parts of the hospital information systems is received via an interface (such as a Rapid Interface Deployment Systems (RIDS) 120 to a database for storing the information (a “persistence” database 140) and to a bank of Event Detection Machines (“EDMs”) 130 which will be described in detail further herein. No additional data entry is required at this time; however, in other embodiments, additional information or inputs such as ventilator usage, catheters, etc. may be captured. The EDMs 130 sort and analyze data, generating alerts for isolates that violate control parameters. As discussed further herein, EDMs 130 may be developed by various techniques, for example, they may be developed and optimized by the use of evolutionary algorithms (EAs).

B. User Interface

The user interface (“UI”) 160 of the present invention is designed so the ICPs can use and interpret the analysis results in a way that allows them to intervene in a timely and effective manner. In one embodiment, the UI 160 allows users to define events of interest and present analysis results in a way that will be easily integrated into the daily routine of infection control. This dramatically increases the capacity of ICPs to find outbreaks and control them in a timely fashion. The UI 160 also allows ICP to identify antimicrobial resistance and formulate focused approaches to appropriate antibiotic use.

More specifically, the UI 160 may use patterns including, but not limited to, disease outbreaks, important changes in the endemic flora of hospital units, shifts in antibiotic resistance, suspicious culturing practices (multiple specimens from one patient, serial daily specimens from the blood of a patient), which suggest clinical infection, and record-level “dangerous” organism alerts (e.g., first isolation of MRSA in a given unit).

In the following paragraphs, a typical user interface functionality will be described. It should be noted that while no actual user interface has been illustrated, one skilled in the art could easily design a user interface that would implement the features discussed herein. The following description of the visual interface refers to standard components of a graphical user interface that may be used with the method and system of the present invention. In one embodiment, the navigation bar may appear on the left of the screen in the browser window. It may comprise subsections that can be accessed by clicking on the arrows on the right of section tabs. For example, to access all the Microbiology navigation tabs, the user may click on the horizontal arrow on the left of the words “Microbiology.” If the user clicks on the words microbiology, the user will instead be taken to the Microbiology section of the application. When the user clicks on the arrow, the arrow turns to point downwards, and the sub-section items are revealed. Clicking on the arrow again will return it to its horizontal position and will hide the subsection tabs.

When the user clicks on a tab, that tab is highlighted. The right hand side of the page is updated to reflect the user's choice of tab. The subsection shown works independently of the tabs selected. For example, the user may visit the Surveillance sub-tab and close the Microbiology subsections by clicking on the arrow, and the user will remain in the Surveillance section on the right side of the page. If the user clicks on the arrow again to reveal the microbiology subsections, the Surveillance choice is still highlighted. If the user does not have access to a particular module, the corresponding choices are grayed out.

A home page contains an overview of items of interest. Because this is an overview, the lists are not complete and contain only the most recent or relevant items from each category (microbiology, incidents, process, improvements, surveys, and configuration). “My Alerts” shows the top few alerts from each category. A new alert may be created by either clicking on a “Create alert” button (a pop-up will ask the user what category the alert belongs to). If the user is not interested in a particular alert, the user may click on “delete.” Even though the alert was deleted, the user will still be able to see it by choosing “show deleted alerts” in the window pane's options. Deleting an alert will only take it away from the user's panel. Other users will still be able to see it until those users delete it themselves. The user can click on “Save” to save changes and redisplay the panel or click on cancel or the options text or arrow to close the Panel Options section without saving any changes to the options.

An alert screen may, for example, show a microbiological alert created by one of the automated monitors provided by certain embodiments of the present invention. Clicking on the alert will take the user to a chart where the potential outbreak will be easy to identify. A second type of alert is created by a doctor, and notifies the user of an incident such as a Patient Fall. Clicking on this type of alert will show the detailed alert text in the Incidents section and will allow the user to visit the event that was linked to the alert. A third type of alert is a survey alert. Clicking on the survey link will take the user to the “quarterly quality improvement survey.” All surveys are accessibly via a “Survey” tab in the navigation bar.

An Overview Calendar is a shrunk down version of the Process Improvement Calendar. Days that have either an event or an action item due are highlighted. The Overview Calendar shows events and action items due on the current day. The user can click on a highlighted box to get a list of events and action items for that day. The user can also change the month by clicking on the arrows on the left and right of the current month. The user can use the options menu to customize how many items are displayed per day.

A search criteria panel in microbiology data serves to specify the criteria used for creating and displaying the charts and reports that are used to create monitors and which can be saved as saved data views. Clicking on any of the tabs at a top of the panel (Organisms, Resistances, Locations, and Specimen Types) saves the data at the current panel and displays the new panel. In certain embodiments, the panels are javascript-based for easy and fast back and forth. When the user has completed filling in all panels or as many as the search requires, the user clicks on a “Include isolates that satisfy all selection criteria” tab to look for the logical “AND” of all the criteria selected for Organisms, Resistances, Locations, and Specimen types. The user can also click on an “include isolate that satisfies at least one of the selection criteria” tab for the logical “OR” of the criteria.

A date range list box may include, but is not limited to, the following selections: Include all dates, Current Month, Current Quarter, Current Year, Month to Date, Quarter to Date, Year to Date, Last Month, Last Quarter, Last 30 Days, and Last 12 Months.

When saving a data view, all the chart settings (including changed advanced parameters) as well as all report settings are saved along with the current view. When visiting the saved charts page and clicking on a saved data view, the system populates the results panel with both the results of the search and the display settings of the charts and the reports.

The options allow the user to add or remove columns. Clicking on an Isolate ID brings up all the isolate details from the database in a pop-up window. Clicking on column headings sort the data by that column as the key. Clicking again reverses the sorting order. Modify populates the search criteria with the current search and returns the user to the search panel.

Saving saves the column layout, the current view (chart or report and sub-views within each). A particular user can only replace data views created by that user unless the user is an administrator or has special privileges.

II. Data Retrieval

Health care data is retrieved in compliance with the Health Insurance Portability and Accountability Act (“HIPAA”) of 1996 that protects the privacy of patient data. In fact, the data do not include any traceable personal information, and the identification numbers do not carry meaning beyond the number value. All hospital data passes through a filter that converts all personal information to untraceable identification numbers before being removed from the site for analysis.

Data may be retrieved using methods and systems known to those of ordinary skill in the art. In one embodiment, a system known as the Rapid Interface Deployment System (“RIDS”) 120 may be used. RIDS 120 is a rich tool kit for swiftly retrieving and updating data in legacy systems. RIDS 120 is programmed to gather essential clinical and demographic data necessary to perform the outbreak detection and other analyses as discussed herein.

III. Data Analysis and Detection Techniques

A. Generally

In certain embodiments, the present invention provides a microbial outbreak detection system that is capable of performing analyses in simulated real-time. FIG. 4 presents one embodiment of the present invention having a filter bank 210, signal generator 230, signal analysis modules, and outputs. The filter banks 210 and the signal generator 230 together encode the attribute associations (e.g., ceftriaxone resistance in blood isolates from the ICU), and the analysis modules (the statistical analysis boxes shown in FIG. 4) detect any events in that data signal. The outputs may include, but are not limited to, alerts or graphical outputs. The analysis modules may comprise a wide range of detection techniques including, but not limited to, simple control charts, event-interval, moving average, binary cumulative sum, and variations thereof.

B. Event Detection Machines

In certain embodiments, the signal analysis modules (together with the digital signal generator) used to implement the outbreak detection system may comprise Event Detection Machines (“EDMs”) 130 shown in FIG. 1. EDMs 130 are not physical machines, but rather a computer program implemented system having one or more states (i.e., node that signifies an input has met certain criteria by virtue of arrival at that node) and one or more transitions (i.e., a connection that directs an input to another node based on whether it meets certain criteria). In a more specific embodiment, a basic EDM 130 architecture such as the classical implementation used for parsing a keyboard entry may be used. In one embodiment, the inputs may be objects of arbitrary type or of a finite set of types. Alternatively, the inputs may be just a single simple data type such as characters. In addition, operations on the inputs may be performed at each state (i.e., node) using Moore states. In certain embodiments, by attaching analytic and signal processing nodes to a filter tree within an EDM 130, the certain embodiments provide highly nuanced and sophisticated analyses in the context of an extendible, scaleable system. In addition, EDMs 130 having flexible logic filters and analytic nodes are quite powerful because of its simple, component-based system architecture. In one embodiment, EDMs 130 may be manually developed or configured by a user using a user interface 160. Alternatively, EDMs 130 may be automatically programmed using evolutionary algorithm (“EA”) techniques as discussed further herein.

An example of an implementation of an outbreak detection event detection machine (“EDM”) is illustrated by FIG. 4. The data stream enters the EDM through the filter bank 210. Parameters are initialized at EDM startup. The signal is sorted and all Enterococcus sp. isolates in Ward A (as an example) are evaluated for vancomycin susceptibility at a Binary Digital Signal Generator 230. The resulting data stream is evaluated using differentially windowed moving averages. In this example, a sudden rise in resistance signaled the outbreak and caused the 20-isolate rolling average to significantly exceed the 1000-isolate rolling average.

C. Filter Banks

Generally, each node in a filter bank 210 is programmed to ask a logical question of an isolate, for example, “Are you an isolate from the ICU?” and lets it pass if the answer is yes. These nodes may be wired together in the EDM 130 to achieve the logic needed. In this regard, the present invention is capable of capturing association rules of arbitrary complexity. For example, in a simple EDM 130 with an A-transition and a B-transition, a binary signal generating C-node is attached. All isolates filter through the EDM 130, and only those matching A & B reach the C-node, which in turn generates a 1 for those matching on C and a 0 otherwise. The data mining support is simply the sum of isolates at the C-node. In certain embodiments, this technique of the present invention goes far beyond traditional data mining techniques for two main reasons: 1) The associations may be much more complex (even allowing for numerical calculations as part of the association rule), which allows for a much more specific classification of the minimal association responsible for an outbreak; 2) The present invention is not limited to binary data, as isolates at nodes can also have quantitative values, for example, a minimum inhibitory concentration (“MIC”).

1. Sufficiency of Logical Operators

EDMs 130 can capture any arbitrary subset of the data by virtue of their capacity to represent a sufficient set of logical operators (AND, OR, and local NOT), which can be used to create all other logical constructs. The sufficiency of the local NOT is guaranteed by DeMorgan's Laws shown in Equations 1 and 2, which state that the complement (NOT) of the union of two sets is equal to the intersection of the complement of each, and the complement of the intersection of two sets is equal to the union of the complement of each.

(A∪B)^{c}=A^{c}∩B^{c} (1)

(A∩B)^{c}=A^{c}∪B^{c} (2)

2. Phenotype Grouping Filter

In one embodiment, a filter bank module may comprise a Phenotype Grouping Filter, a self-generating filter that may also be a part of an EDM 130 that produces an isolate-sorting filter tree. The Phenotype Grouping filter in EDM 130 may separate incoming isolates into appropriate bins based on their antibiotic resistance phenotype, i.e., the set of antibiotic sensitivity results of a given isolate. Analytic processing nodes such as the Binary Signal Generator may be attached to the bin of interest, and a binary signal may be generated only for the isolates within that bin. In order to abstract beyond phenotypic instability, the present invention may, for example, provide for fuzzy logic determination of resistance phenotype sets.

D. Signal Generators

In a particular embodiment, the signal generator takes an isolate record and turns it into symbolic representation, such as a number. One example is a binary signal generator that produces a 1 if the answer to its question is “yes,” and a zero otherwise. For example, “Is your MIC to vancomycin>16 μg/ml?” may be translated to a 1 if the answer is yes and to a zero otherwise. In an alternative embodiment, a signal generator may use continuous values or perform calculations taking several parameters into account as would be configurable by one skilled in the art in view of the teachings herein. Certain embodiments also have the ability to deal naturally with integer or continuous data such as raw MICs rather than only dealing with binary values which can decrease sensitivity.

E. Analysis Modules

The EDM 130 architecture allows for a natural implementation of even extremely complex cluster detection techniques developed and used in various settings. Such detection techniques include, but are not limited to, simple control analysis, moving average analysis, event-interval analysis, cumulative sum (“CUSUM”), scan statistics, empty cell analysis, Fourier and Wavelet transforms, and last squares regression. These techniques are discussed in the following paragraphs.

1. Simple Control Analysis

In one embodiment, a simple control analysis module may utilize the common statistical process control c-chart. The module may track, for example, monthly isolate counts at various nodes in relevant EDMs 130. The upper control limit (“UCL”) of a c-chart when based on historical or real-time data may be calculated, for example, using Equation 3:

UCL= x̅+k{square root over ( x̅ (3)
where x̅ represents the mean of monthly counts, and k is the central reference.

2. Moving Average Analyses

In the application of moving average (“MA”) techniques to data signals, simple techniques may be combined in complex ways. For example, a single moving average node and a differentially windowed moving average (“DWMA”) node that tracks two moving averages with different window sizes may be used. For both of theses techniques, the r-bar standard deviation calculation may be used for the underlying data, as shown in Equation 4. For the single moving average node, the upper control limit may be calculated using Equation 5. For the DWMA, the upper control limit may be calculated using Equation 6.

$$\overline{r} = \frac{1}{n} {\sum }_{n = 1}^{w} \vert {x}_{n} - {x}_{n - 1} \vert \qquad ( 4 )$$

where w is the number of values in the rolling average 240 window.

$$\begin{matrix}U C L = \overline{x} + k \frac{\overline{r}}{1.128} ( \frac{1}{w} ) & ( 5 ) \\ U C L = {\overline{x}}_{Δ} + k \frac{\overline{r}}{1.128} \sqrt{\frac{1}{{w}_{1}} + \frac{1}{{w}_{2}}} & ( 6 )\end{matrix}$$

where w₁ is the number of values in the first rolling average 240 window, w₂ is the number of values in the second rolling average 240 window, x̅ the average of all incoming values, x̅_{Δ} is the average of all incoming rolling average differences 250, and k is the central reference.

For moving averages with various window sizes, the delta of two moving averages of distinct window sizes may be taken and the delta signal may be charted. Statistical analysis of this method may be used to determine the optimal detection criteria, control limit calculations, and resultant sensitivity, and specificity as would be within the abilities of those skilled in the art in view of the teachings herein. The analysis also requires estimation of the standard deviation and probability distribution of the deltas and the correlation between the two moving averages, as they are not independent random variables. Similar performance/detection analysis is conducted for the Exponentially Weighted Moving Average (EWMA) and Cumulative Sum (CUSUM) interval methods in order to determine how to optimally set their parameters and probability-limits.

3. Event-Interval Analysis

Given the small size of data subsets and the relatively low rate of critical events, two specially tailored tools may be applied. Analysis nodes based on the statistical process control g-chart and an auto-regressive version, the exponentially-weighted moving average g-chart (EWMAGC), may be used. BENNEYAN ET AL., ASQC ANNUAL QUALITY CONGRESS TRANSACTIONS 32-42 (1994); Kaminsky et al., 24(2) J. QUALITY TECH. 63-9 (1992); Benneyan, Statistical control charts based on geometric and negative binomial populations. Master's thesis, University of Massachusetts, Amherst (1991). Both charts track event-intervals, the length of time between events of interest, and the EWMAGC incorporates a moving average with an exponential decay coefficient λ. G-chart alert limits may be determined in two ways: based on k-standard deviations or on a user-specified probability. In both cases, the lower control limit (LCL) is of primary interest, because a decreasing event-interval represents increased frequency of occurrence. The k-sigma LCL may be calculated using Equation 7.

LCL= x̅−k\sqrt{x̅( x̅+1)} (7)

where k represents the number of standard deviations used in the control limits, and x̅ represents the mean event interval.

For Probability-Limit G-charts, the current event interval (vₓ) is the plotted point, with CLᵢ, LCLᵢ, and UCLᵢ calculated as shown in Equations 8-10.

$$\begin{matrix}C {L}_{i} = \frac{ln ( 0.5 )}{ln ( \frac{{\overline{x}}_{i}}{{\overline{x}}_{i} + 1} )} & ( 8 ) \\ L C {L}_{i} = \frac{ln ( 1 - α )}{ln ( \frac{{\overline{x}}_{i}}{{\overline{x}}_{i} + 1} )} \\ U C {L}_{i} = \frac{ln ( α )}{ln ( \frac{{\overline{x}}_{i}}{{\overline{x}}_{i} + 1} )} & ( 9 )\end{matrix}$$

where 2α is the user-specified probability of a “false alarm” (i.e., 1−2α is the total specificity of both control limits, typically set between 0.005-0.1), and is the mean of all event intervals up to and including the i^{th} isolate.

For EWMAGC, the plotted point (zi), CL, UCL, and LCL are calculated using historical data as shown in Equations 11-14.

$$\begin{matrix}{z}_{i} = λ {v}_{x} + ( 1 - λ ) ( {z}_{i - 1} ) & ( 11 ) \\ C {L}_{i} = {\overline{x}}_{i} & ( 12 ) \\ L C {L}_{i} = {\overline{x}}_{i} - k ( \sqrt{{\overline{x}}_{i} ( {\overline{x}}_{i} + 1 )} ) ( \frac{λ ( 1 - {( 1 - λ )}^{2 i}}{2 - λ} ) & ( 13 ) \\ U C {L}_{i} = {\overline{x}}_{i} + k ( \sqrt{{\overline{x}}_{i} ( {\overline{x}}_{i} + 1 )} ) ( \frac{λ ( 1 - {( 1 - λ )}^{2 i}}{2 - λ} ) & ( 14\end{matrix}$$

where i is the number of isolates processed, vₓ is the event-interval corresponding to the i^{th} isolate, x̅ᵢ is the mean of all event intervals up to and including the ith isolate, zᵢ is the EWMA of all event-intervals up to and including vₓ, zᵢ−1 is the EWMA up to and including xᵢ−1, λ is the weighting coefficient, and k is the central reference (standard deviation multiple). A zᵢ that is lower than LCLᵢ (or above UCLᵢ) will trigger an alert.

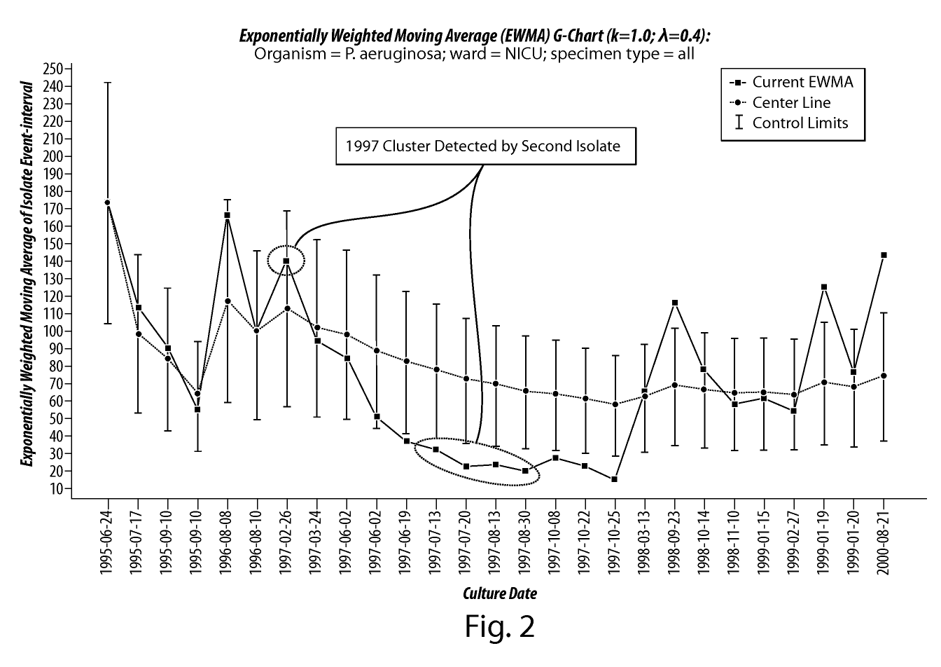

An example EWMAGC 101 is shown in FIG. 2. FIG. 2 provides an Exponentially-Weighted Moving Average G-Chart (“EWMAGC”) (k=1, λ=0:4) of Pseudomonas aeruginosa (“PAE”) in the neonatal intensive care unit (“NICU”) of all sites, Jan. 1, 1995 to Oct. 1, 2000. This example excludes outside and non-routine surveillance cultures. An alert is generated at the second genotypically identical isolate.

4. CUSUM

The cumulative sum (CUSUM) is a technique from industrial engineering for monitoring manufacturing processes which has been broadly applied in healthcare. Bolsin, 12 INT. J. QUAL. HEALTH CARE 433-38 (2000); Hutwagner et al., 3 EMERG. INF. DIS. 395-400 (1997); Williams et al., 304 B.M.J. 1359-61 (1992). Although there are several types, all CUSUMs track a cumulative sum of values. For example, a binary (Bernoullian) version treats successes and failures as ones and zeros, subtracts a weighting coefficient, and monitors their behavior. In one embodiment, antimicrobial resistance may be treated as a failure and susceptibility as a success by attaching a binary CUSUM node to a binary signal generator which outputs 1 for resistant results and 0 for sensitive results.

User defined values α, β, p₀, and p₁, may be used to determine the constants specified in Equations 15-17, where α is the Type I error rate, β is the Type II error rate, p₀ is the acceptable failure rate, and p₁ is the unacceptable failure rate.

$$\begin{matrix}a = ln \frac{1 - β}{α} , b = ln \frac{1 - α}{β} & ( 15 ) \\ P = ln \frac{{p}_{1}}{{p}_{0}} , Q = ln \frac{1 - {p}_{0}}{1 - {p}_{1}} & ( 16 ) \\ {h}_{0} = \frac{b}{P + Q} , {h}_{1} = \frac{a}{P + Q} , {h}_{2} = \frac{Q}{P + Q} & ( 17 )\end{matrix}$$

If an incoming binary value is equal to 1, the cumulative sum is incremented by 1−s. If the value is 0, the cumulative sum is decremented by s. The cumulative sum itself is plotted, and its behavior is constrained by control limits which are calculated from h₀ and h₁, where h₀ defines the distance between unacceptable failure limits which increase as the CUSUM exceeds them, and h₁ defines the spacing between acceptable rates.

In another embodiment, a quantitative CUSUM may be used, in which the current value (not limited to 0 or 1) is added to an s factor to increase or decrease the cumulative sum. Kinsey et al., 299 B.M.J. 775-76 (1999); Hutwagner et al., 3 EMERG. INF. DIS. 395-400 (1997).

5. Scan Statistic

The scan statistic moves a fixed window across a data set, advancing one day, for example, at a time. A window with a higher than anticipated count may indicate a cluster. Jacquez et al., 17(5) INFECT. CONTROL HOSP. EPIDEMIOL. 319-27 (1996); Jacquez et al., 17(6) INFECT. CONTROL HOSP. EPIDEMIOL. 385-97 (1996); Wallenstein et al., 12(19-20) STAT. MED. 1829-43 (1993); 48. Stroup et al., 8 STAT. MED. 323-32 (1989). The scan statistic approach is a good match for the EDM 130 architecture, as a day-collecting node can output its window contents with each incremental day, passing those values to another analysis node.

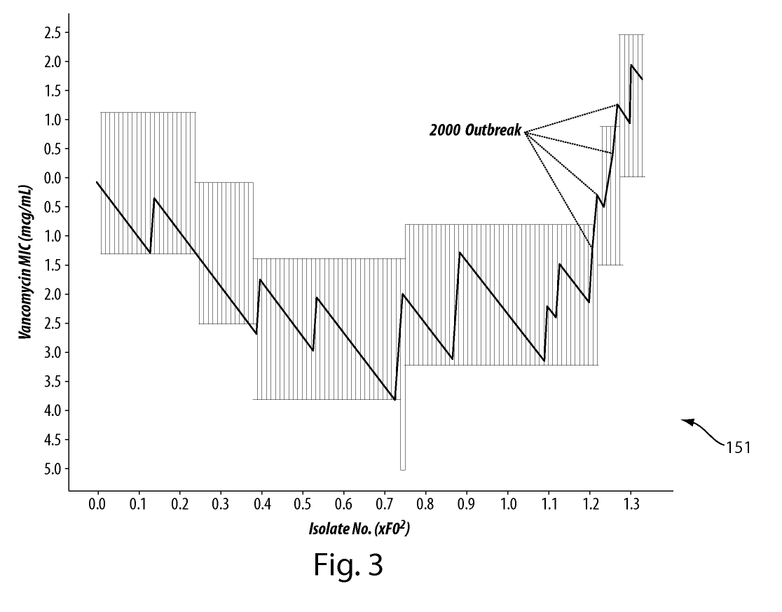

An example of binary cumulative sum analysis is shown in FIG. 3. FIG. 3 illustrates binary cumulative sum (“CUSUM”) analysis 151 of vancomycin resistance in Enterococci. CUSUM analysis is completed for VRE (α=0.05, β=0.15, ρ₀=0.05, ρ₀=0.15) in the bone marrow transplant (“BMT”) unit and ICU. An alert is generated at the second cluster isolate.

6. Empty Cell Analysis

Empty cells analysis assesses whether a given cell (subdivision of the dataset) has a sufficiently large number of empty neighbors. Jacquez et al., 17(5) INFECT. CONTROL HOSP. EPIDEMIOL. 319-27 (1996); Jacquez et al., 17(6) INFECT. CONTROL HOSP. EPIDEMIOL. 385-97 (1996).

7. Transforms: Fourier and Wavelet

Fourier and Wavelet transforms may be used in describing the seasonality of inpatient microbiology data and as an analytic module to be added to EDMs 130 and optimized using EM. Iterative transforms may be compared for the onset of a new spike indicating a sudden sub-signal with distinct periodicity, possibly suggestive of an outbreak or a new trend in the data.

8. Least Squares Regression

It may be important to determine the seasonal component of a signal, if any. Although winter and fall may be associated with increased nosocomial pneumonia risk (Craven et al., 133 AM. REV. RESPIR. DIS. 792-96 (1986)), Acinetobacter infection appears to occur more in summer (McDonald et al., 29(5) CLIN. INFECT. DIS. 1133-37 (1999)), and, in general, the seasonality of nosocomial infections is poorly characterized. Surgical infections may increase each summer with the advancement of new cohorts of young physicians. Least-squares regression is a well known statistical technique used in economics for, among other things, removing factors such as seasonality. If there is a property of the input data set that is computable from the input data set and whose effect is known to be irrelevant, then it is possible to use least-squares regression to remove its effect. For example, suppose that the number of infections goes up in the winter, but this is not interesting from an epidemiological perspective. Given a data set where xᵢ is the number of infections on day i, create a dummy variable wᵢ that is 1 if i is a winter day and 0 if it is not. The number of “interesting” infections, x′ᵢ, could be modeled as the following:

x′ᵢ=xᵢ+αwᵢ

The filter would chose α to minimize (x′ᵢ−xᵢ−αwᵢ)². Given the set {xᵢ}, it would output {x′ᵢ}, allowing subsequent filters to ignore the effect of constant changes in infection rate in the winter (though the filter may have to pass on error statistics if subsequent filters do hypothesis testing).

F. Phenotyping

There are two commonly available methods for phenotyping bacterial strains: antibiotic resistance profile, and the biochemical or enzymatic profile. Although there is extensive literature discussing the correlation (or lack thereof) of resistance phenotype and genotype much of the work has been retrospective comparison of outbreak antibiograms and genotypes or comparison of susceptibility to a single antibiotic in bacteria of a given species with a known shared resistance gene. Lee et al., 21(3) INFECT. CONTROL HOSP. EPIDEMIOL. 218-21 (2000); Essawi et al., 3(7) TROP. MED. INT. HEALTH 576-83 (1998)1 Mulligan et al., 26 J. CLIN. MICROBIOL. 2395-2401 (1988); Weber et al., 11(2) DIS. CLIN. NORTH AM. 257-78 (1997). These studies have not answered the important question of whether distinctive phenotypes are surveillance objects which may be prospectively useful in cluster detection. Several significant outbreaks (one national) have been detected on the basis of prospective resistance phenotyping. Stelling et al., 24(Suppl. 1) CLIN. INFECT. DIS. 157-68 (1997); Boyce et al., 161(3) J. INFECT. DIS. 493-39 (1990); O'Brien et al., Banbury Report 24 (Cold Spring Harbor Laboratory (1987). In addition, very little work has been done to optimize phenotype comparisons. In the context of the present invention, a module within an EDM 130 may be used to sort antibiograms by strict definitions. For example, a fuzzy logic antibiogram sorter which can use varying levels of tightness of fit to sort antibiotic sensitivity results may be used. Various rules for identity may be implemented to see how well they improve outbreak detection, for example, strains may differ by two dilutions in one antibiotic result or by one dilution in two antibiotic results, a common practical rule. In addition, useful phenotype attributes may be incorporated into the phenotype grouper. Initial training of the fuzzy logic functionality may be performed on outbreaks investigated as well as on additional outbreak reports of high quality in the literature.

The phenotype matcher may be extended into the biochemical realm and the biochemical profile may be included in determination of species identity. Although such data have played a role in outbreak detections in the past there is no careful characterization of their utility in surveillance. Stelling et al., 24 (Suppl. 1) CLIN. INFECT. DIS. 157-68 (1997); Boyce et al., 161(3) J. INFECT. DIS. 493-39 (1990); O'Brien et al., Banbury Report 24 (Cold Spring Harbor Laboratory (1987). Biochemical phenotype may be integrated into the overall phenotype matcher.

G. Genotypic Analysis

In order to further develop capacity to monitor phenotypes prospectively, it is important to correlate phenotypic information with the results of genotyping. While recognizing that certain genotypes can become predominant in various wards, genotyping has frequently demonstrated its worth as a technique for further elucidating strain identity. In order to provide this clarification, Pulsed Field Gel Electrophoresis (PFGE) genotyping may be performed on certain isolates prospectively. This information may be used to further evaluate possible clusters, validate predictions of certain embodiments of the present invention, and optimize the Phenotype Grouping Filter.

In one embodiment, PFGE may be performed on isolates meeting the following criteria: those generating an alert that domain experts rate as A (investigate); vancomycin-resistant Enterococci; methicillin-resistant Staphylococcus aureus; ceftazidime-resistant Pseudomonas aeruginosa; enteric Gram-negative rods resistant to third-generation cephalosporins. Every six months or at some other periodic interval, an interim analysis may be conducted in each hospital. If genotyping is no longer informative (a single strain significantly predominates, all resistant organisms of a given species are genetically distinct), for example, PFGE may be limited to organisms that caused A-rated alerts.

IV. Evolutionary Algorithms

A. Generally

In certain embodiments, the present invention contemplates the application of evolutionary algorithms (EAs) and other techniques to the problems of event detection. In particular, the present invention involves the application of evolutionary algorithms to find new combinations of analysis modules that will detect events sooner with fewer false positives so that they can be used for predictive purposes. In one embodiment, EAs may be used to nonintuitively fine tune or optimize the manually designed EDMs 130. Alternatively, EAs may create novel EDMs 130 that have not been considered.

By way of background, EAs roughly mimic the process of biological evolution. For example, potential solutions to a problem are like the organisms, fighting for survival in the environment which is represented by the so called “fitness function.” The fitness function assigns each candidate solution a score representing its fitness based on its performance at accomplishing a task. The solutions are represented in a way such that they may be decomposed into a set of well-defined building blocks, which roughly compare to genes in DNA (to carry the analogy all the way to the molecular level).

EAs represent a subset of evolutionary computation which is a part of artificial intelligence. They use optimization solution algorithms that use mechanisms from biological evolution, such as reproduction, mutation, recombination, natural selection, or survival of the fittest. Candidate solutions to the optimization problem play the role of individuals in a population and a cost function (or a fitness function) determines the environment within which a solution lives. Evolution takes place after repeated application of the operators and evaluations of the cost function (or fitness function). Some examples of EAs include: genetic algorithms, evolutionary programming, evolution strategy, learning classifier system, or genetic programming.

One example of the use of EAs was the completely automated design and construction of robots by a computer. The human operators specified the building blocks (wheels, gears, motors, processor, etc) and the computer randomly connected the parts, in several configurations, and then evaluated the fitness of each. Specifically, the fitness was evaluated by the robot's ability to move; the further and faster it could move, the higher fitness score it got. The most fit robots where chosen for reproduction, and offspring robots where formed by combining traits from two parent robots. The new generation was then evaluated, and the process continued on for several generations.

EM evolve their solutions by measuring the success of each solution using the fitness function and then producing a new set of solutions using combinations of the best solutions from the prior generation. The first generation may be seeded by producing solutions at random. In one embodiment, the same EA may be run many times with different initial generations, and the best solution may be taken from all runs.

1. Representing EDM Optimization as an EA

EA's may be used in the evaluations of several different detection methods, including g-charts, c-charts, rolling averages, standard deviations, cumulative sums, limit filters, etc. as discussed earlier herein. Each of these methods is dependent on the preprocessing of the signal, as well as several parameters that affect their sensitivity. A very limited number of possible combinations of such methods are useful for detecting outbreak events. In addition to simple analysis types, experiment with complex analysis types, joined by combining analysis modules, such as the differentially windowed moving average analyses may be used. More complex combinations of these analysis modules may provide an even more robust system for detecting outbreaks. Using EAs to search for more optimal combinations of analysis modules will provide more successful systems. One can validate such systems by evaluating them on a large number of datasets and rating their performance across all sets. This can be accomplished by exhaustive testing on the testing data sets as well as during the real-time trial.

Selecting the Encoding and Primitives: The first requirement to use EAs is to have a genetic encoding that defines the search space. Unlike typical EA applications where the size of solutions is fixed, our solutions need to be of arbitrary size and complexity (within an acceptable range). Our generic encoding is the graph representation of a candidate EDM 130.

The individual values of a signal are fed into the top of our graph sequentially; each could possibly trigger an alert. The conceptual goal is to generate an alert at the first isolate which indicates an outbreak and not before.

Create Fitness Function: The fitness function for an EDM 130 is a function of the machine's behavior, and it should reward early detection of validated outbreaks and punish false positive alerts. One possible fitness function is shown in Equation 18 where D is the input number on which an outbreak was detected, A is the input number of the actual start of the outbreak, and V is the number of vertices (nodes) in the EDM 130. This fitness function equally punishes detection before or after the actual start, and punishes very complex EDMs 130 (high V) which should correlate roughly with computation time.

$$Fitness = \frac{1}{N} {\sum }_{i = 1}^{N} 1000 ( 1 - \frac{\vert {D}_{i} - {A}_{i} \vert}{{A}_{i}} ) - {V}_{i} \qquad ( 18 )$$

Create Training Data: Training data will typically come from two sources. The fully characterized real data sets, with specification of relevant isolates in clusters are one source. Another source is Monte Carlo simulations, in which random numbers with known statistical parameters are generated. These simulations are a standard statistical method for validating detection techniques and allow precise specification of the onset of an outbreak, which will be documented with each Monte Carlo synthetic cluster. The EAs will be validated (tested for generality) by running the discovered EDMs 130 on the testing portion of the historical data as well as on the simulated data.

2. Running the Evolutionary Algorithms

Step 1. Create Generation 0: On the primary processor, generation 0 is created by randomly connecting analysis modules into graphs. First a Start and an Alert (accept) node are added to the EDM 130. Second, a random number (for example, between 1 and 100) of primitives are added to the EDM 130. The parameters of each primitive are set at random (each parameter provides an acceptable range). Then a random number (in the range of V to 3V) of transitions will be added to the EDM 130. The graph is then trimmed by removing any branches that do not come from Start or terminate at Alert (to save wasted computation time); if there is not at least one path from Start to Alert, the solution dies immediately.

Step 2. Calculate the Fitness: Fitness calculation is handled by one of the machines in the processor array. For efficiency reasons, each machine has a local disk with a copy of the training data which is downloaded from the fileserver once at the beginning of the test in order to reduce network traffic and latency. The fitness is calculated iteratively using a fitness function similar to the one shown in Equation 18. If at any time the fitness drops below a level that would prevent it from achieving a composite score above the mean of the last generation, testing is stopped, and it retains its current score. More concisely, if Equation 19 evaluates to TRUE, then testing is stopped. This is a performance optimization that will speed analysis of the substantial problem space involved without substantial negative impact on selection, as the missed iterations have lower overall fitness and are unlikely candidates for selection or crossover.

$$LastMean > \frac{1000 ( N - n )}{N} + \frac{1}{N} {\sum }_{i = 1}^{n} 1000 ( 1 - \frac{\vert {D}_{u} - {A}_{u} \vert}{{A}_{u}} ) - {V}_{i} \qquad ( 19 )$$

Step 3. Apply Selection, Crossover and Mutation: In order to carry those traits forward into future generations that have the highest chance of producing a viable solution, probabilities for selection which favor the more fit solutions are defined. Our initial approach to this problem is to rank the solutions in order of fitness, the rank (r) of zero being assigned to the most fit, and a rank of n−1 assigned to the least fit where n is the population size. Solutions may be eliminated from the population using a probability of r/n. That process will leave us with m empty spots in the population, which will be filled by the mating (crossover) of the remaining members. Starting with the highest ranked member, members will be allowed to mate with approximately 50 percent probability. All members may be cycled through until all empty spots in the population are filled.

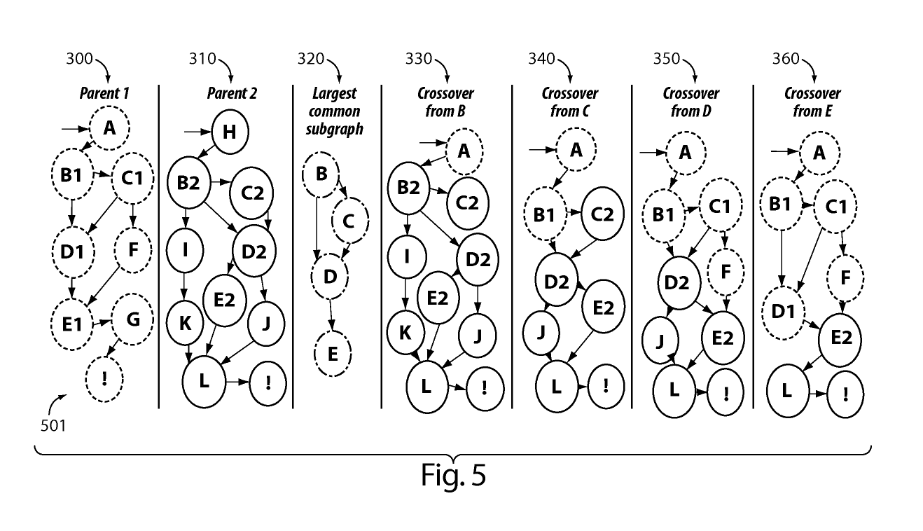

When chosen for mating, members will have a higher probability of mating with members with a similar graph topology and a higher probability of mating with members with higher fitness. Although fitness is based on the traits, or semantics, of any particular EDM 130, the process of mating and crossover between two candidate solutions is based on the encoded graph representation of the EDM 130. As shown in the exemplary diagram 501 in FIG. 5, mating (crossover) will occur by determining the largest common subgraph 320, choosing an arbitrary node within the common subgraph as the crossover point, and building a new graph taking the “upstream” subgraph (the nodes and edges that reach the crossover point from the start node) from one graph and the “downstream” subgraph (the nodes and edges that reach the end node from the crossover point) from the other. If two members have no common subgraph, then they will simply both be joined to the same Start and Alert nodes. See diagram 501 in FIG. 5 for an example of the cross over and mating process.

This mating process has wide applicability and provides a large payback. The difficulty is in creating a mating scheme that will not only produce a viable offspring as often as possible, but also have reasonable chance of getting favorable characteristics from each parent. This approach will clearly favor the mating of two graphs with the same species (topology) since the topology has proven effective, and the crossover occurs completely at the parameter level similar to traditional EAs. Yet over time, new species (originally produced by topology crossover) may begin to compete for the mostfit positions. This can only happen if an environment is provided in which multiple species can survive long enough to reproduce through several generations, giving them enough time to fine tune their parameters and compete with the other species.

Three types of mutations can occur, with the first having the highest probability. (1) Change the value of a parameter: increase or decrease it by some small amount. (2) Prune: remove a vertex in the graph as well as any dangling branches that occur as a result. (3) Change vertex type: replace a primitive by some other primitive. Once we have a full population, we go back to step two, calculating fitness for the new members of the population.

An example of EDM crossover using evolutionary algorithms is shown in FIG. 5. In this crossover between two mating EDM graphs, each choice of a crossover node produces a different offspring. The upstream subgraph comes from parent 1, and the downstream subgraph comes from parent 2. Four additional offspring (not shown) are possible by switching the roles of parent 1 and parent 2.

3. Is this problem a good match for Genetic Algorithms?

This problem space meets the most common definition of a domain that is a good fit for EM. De Jong lays out the criteria: “If the space to be searched is not so well understood, and relatively unstructured, and if an effective EA representation of that space can be developed, then EM provide a surprisingly powerful search heuristic for large, complex spaces.” De Jong, 5(4) MACHINE LEARNING 351-53 (1990). The space of all possible EDMs 130 with all possible parameterizations for the set of primitive is infinite and far from well understood, meeting his first criteria. His second criterion is met by our event detection machine architecture which is an effective representation of that space. Evaluation of the fitness function will be computationally intense as it requires the passing of several entire datasets through each EDM 130 at each generation, and will require significant parallel computing power, but it is achievable.

The use of parallel processing: in an exemplary implementation, a set of analysis consisting of running 200 associations with 1000 isolates through EDMs 130 with 10 nodes took on the order of 24 hours running on a 1 Ghz AMD Athlon processor with 512 MB ram. A similar workload for each generation of our EAs is anticipated. Assuming we will need to run each for at least 150 generations, it quickly becomes apparent that this problem is far beyond the scope of a single processor. We have designed our system to scale naturally to parallel processing environments, and hence we anticipate an almost fully linear speedup with the addition of each processor (Typically the actual speedup falls of by some percentage with the addition of each new processor). By using a 64 CPU Linux cluster to address this problem, it is anticipated to lower the 150 days on a single processor to less than two days for each run. If we leap-frog runs, this will allow us one day to analyze the results of the last completed run, and one day to prepare parameters for the next run, and hence keep the cluster completely utilized, maximizing return on investment.

V. Signal Decomposition Based Segmentation

Suppose the hint of an outbreak has been detected. For instance, when looking at the resistance to penicillin for all isolates, the value may seem to be higher than the norm for the past two days. It would be extremely advantageous for the ICPs to know exactly what that subset is what they have in common.

For example, if there is a detected spike in vancomycin-resistant Enterococci in the intensive care unit, a specific commonality may be found that explains the sudden increase. For example, it might turn out that a large number of these isolates might come from female patients.

Although at first glance it seems as if one could pick all the isolates that are higher than the norm and find what they have in common, the problem quickly grows out of control in the general case. The robust way to do it is using “Signal Decomposition Based Segmentation.” The basic idea is that if you see a bump (or a ramp) in a signal, and want to find out what caused it, simply search for the narrowest association (which produces the least number of isolates) which when subtracted from the original signal removes the bump.

This is the search space which many traditional data mining techniques attempt to address. Data mining concerns itself partially with determining associations that were not previously appreciated, as well as determining how the associations have changed with time. Brossette et al., 39 METHOD INFORM. MED. 303-10 (2000); Moser et al., 5(3) EMERG. INFECT. DIS 454-57 (1999).

Different types of searches may be used to find the most specific commonality between isolates that could explain a sudden increase in antibiotic resistance. In this regard, EAs are particularly valuable because the search space is large and the fitness function is relatively easy to evaluate. If an association shows a strong presence of an event, it will be given a higher fitness rating than those that do not. This aspect of the present invention is also applicable to the set-covering model for diagnostic problems where the goal is to find the narrowest diagnosis for a set of observed symptoms (Reggia et al., 19 INTL. J. MAN-MACHINE STUDIES 437-60 (1983)).

VI. Minimum Entropy Partitioning and the RIGMAX Heuristic

A. Generally

In certain embodiments, the present invention provides that proper clustering of microbiology data can improve the performance of statistical monitoring, in terms of specificity, timeliness, and sensitivity. In certain embodiments, it focuses on using statistical process control (SPC) techniques to monitor for outbreaks caused by a single organism, such as Staphylococcus aureus. Bacterial organisms, however have evolved over time a resistance to several antibiotics used to treat bacterial infections. The population of a hospital is filled with several genotypically distinct strains of a single organism, each exhibiting a different set of resistance and sensitivity patterns, known as an antibiotic susceptibility profile (ASP), or phenotype.

Since genetically identical strains have a single phenotype, by monitoring for phenotypically similar strains one can improve the sensitivity and specificity of SPC monitoring. In certain embodiments, the present invention provides a way of measuring the effectiveness of a clustering of antibiograms, a structure for representing a clustering rule as a tree of attributes, and a heuristic for choosing an adequate clustering rule. This approach is a marked improvement over monitoring all strains of a particular organism together as a single process, or manually choosing aggregation of subsets of the entire organism through manually selected resistance profiles (i.e., all Staphylococcus aureus resistant to ampicillin).

This problem could be applied beyond the application of phenotypic straining. Besides also being applicable to genotypic straining, one could use this system to hierarchically partition other data items with a set of attributes that describe them.

B. Minimum Entropy Partitioning

The partitioning approach described herein can produce both clusters and coverings. Both clusters and coverings separate items into different sets, but clusters are mutually exclusive where coverings are not. In certain embodiments, the clustering/covering rules are represented as partitioning trees, which are known as decision trees in the data mining literature when used for classification and not for clustering.

In a partitioning tree, each leaf node corresponds to a cluster of data points with several common features. Each non-leaf node corresponds to a particular attribute of the data, and is used to partition the data according to that attribute. Each child node corresponds to data that have a particular value or (set of values) for the parent's attribute. To identify the cluster of a particular item, simply traverse the tree from the top, navigating toward a leaf based on their attribute values. The cluster is fully described by the decisions (edges) made to get to that leaf.

C. Entropy-based Scoring

This algorithm tries to find trees that balance complexity against cluster purity. Any tree separates the data into clusters, and each cluster will having some level of similarity among items in the cluster, by virtue of the method used to define clusters. As one traverses further down any tree, an increasingly restrictive set of criteria is created. Not all trees, separate the data as effectively. Certain attributes with high uniformity will not effectively partition the items, and are poor choices for branching nodes. Similarly, one could construct a complete tree where each leaf corresponds to a unique set of attribute values. Each leaf would be uniform (since the items of each cluster have identical attribute values for all attributes), but the tree would be large indicating a complex clustering rule.

A clustering rule (tree) can be scored by the similarity of each item in a cluster (leaf). To compute the effectiveness of any tree at creating pure clusters, one measures the entropy (from the well known Shannon's Information Theory) of each leaf. The clustering rule's score (tree entropy) is the weighted average of the entropies of each leaf's items. The weight used for each leaf is proportional to the number of data items classified or clustered in each leaf.

Complexity of a tree is bounded by setting a maximum size for the tree, measured in leaves, depth, or some other complexity metric. In certain embodiments, the current metric chosen is the maximal size of the tree.

D. Finding an optimal tree

To find the optimal tree, or minimal entropy partitioning, one must go through all trees that meet the complexity requirement, and evaluate the average entropy of each tree. For each complexity metric, many distinct trees meet the requirements. For example, if the complexity metric requires all trees to have k leaves, the number of trees that have k leaves is large for a given k. In addition, the number of attributes (n) has an exponential effect on the number of unique trees to inspect. Pruning rules can be implemented but the growth is still exponential in terms of n and k. As such, we must have a heuristic to help us identify how to choose a minimum entropy tree as discussed in the following section.

E. Relative Information Gain

A tree is built from the top down, by discovering which split produces the maximal relative information gain. First, the entropy of all attributes (Z) is computed. For each attribute X, the entropy of the attribute is computed, along with the entropy of all other attributes in Z excluding X, denoted Y. The relative information gain (RIG) of Y given attribute X is computed, as defined in the data-mining literature as RIG(Y|X). The choice of X with the highest relative information gain is used for splitting the data.

Once an attribute is chosen, a child node is created describing all elements where the given attribute has the value of that decision edge. The algorithm is recursively applied for each branch, until the entropy of each child is 0 when all items are uniform.

Trees are then pruned to have a required size by choosing how deep to expand the tree at each point that produces the minimum average entropy tree.

F. Phenotype Applicability

For using the above approach to partitioning isolate data, one must first identify the “basis” attributes that are common to some plurality of isolates. In particular, before clustering, one must identify the antibiotics which have been tested for the vast majority (90%) of all isolates. Additionally, intermediate and missing values can be accounted for either by discounting these isolates from the clustering procedure, or by using a covering approach.

G. Other Applications

The minimum entropy partitioning discussed herein has wide applicability in many other fields beyond the phenotype straining discussed previously. A minimum entropy partitioning (MEP) of data creates a tree structure that represents the key attributes of the data that identify each similar group (cluster) within the data. As such, all domains that benefit from traditional clustering techniques in data-mining could benefit from MEP.

For example, as organisms evolve or mutate, variations are introduced that manifest themselves as a single nucleotide polymorphisms (SNP) or also as antimicrobial susceptibility data. Each change in the underlying DNA of a part of the organism's population can be organized as a tree. Each branch corresponds to a split caused by a mutation, with one child corresponding to those that have this mutation, and the other branch corresponding to those that do not. This hierarchical structure is best represented by MEP since it attempts to capture the natural splitting phenomenon.

MEP is also applicable in identifying groups of people by certain key features about their behavior or appearance, as usable, for example, in a terrorist detection system for homeland security. In this example, all items correspond to potential suspects and attributes are key characteristics about each individual that may be useful in classifying a terrorist from those that are not terrorists (for example, membership to certain groups, association with key individuals, certain ticket purchase patterns, or certain communication patterns, etc.) MEP could be used to group these individuals into similar groups, and also identify the key attributes that make them similar.

MEP is also applicable to problems which require automatic taxonomy generation. MEP can separate groups of products by key distinguishing features. Additionally, MEP has shown some experimental value in partitioning state spaces of robots to identify key situations.

### EXAMPLES

### Example 1 (See FIG. 2—EWMA G-Chart)

This Example utilized well-characterized data sets to certain embodiments of the present invention.

All inpatient microbiology results were extracted for the period Jan. 1, 1995 to Oct. 1, 2000 from the Children's Hospital Clinical Data Repository via BacLink into WHONET. Using infection control records, all outbreaks for which isolate strains had demonstrated genotypic identity were selected. Three datasets of the organisms of interest were generated, and each data set was analyzed using the present invention in an attempt to detect the following outbreaks:

Outbreak 1 (O1): An outbreak of Pseudomonas aeruginosa (“PAE”) in the neonatal intensive care unit (“NICU”) occurred during July and August 1997. There were five cases of rapidly progressive sepsis syndrome caused by isolates of a single genotype, which matched that of a healthcare worker with intermittent otitis externa. Four cases were fatal.

Outbreak 2 (O2): An outbreak of vancomycin-resistant Enterococcus (“VRE”) occurred during May and June 2000 involving two units with shared patients, the bone marrow transplant (“BMT”) unit and a multidisciplinary intensive care unit (“ICU”). Disease transmission occurred from the BMT unit to the ICU. Isolates from five patients were demonstrated to be genotypically identical.

Outbreak 3 (O3): An outbreak of cardiac surgical infections caused by methicillin-resistant Staphylococcus aureus (“MRSA”) occurred during the August to September 1999 timeframe. A single genotype of MRSA was isolated from four patients with evidence of deep/organ-space surgical infection following cardiac surgery. Two surgical patients without clinical infection were colonized with a second genotype.

Any isolates found within sixty days of the first isolate of a given species from the same patient, for a given analysis, were considered duplicates and excluded. Analyses were limited to the wards affected by the outbreaks. Indication for culture was specified as either clinical (“C”), routine surveillance (weekly stool screens or sentinel event unit screens) (“R”), or outbreak investigation (cultures taken as part of a formal or informal outbreak workup) (“O”). Culture indications were determined from IC records. Data sets were passed through various EDMs 130. For event-interval analyses, the time from the first possible isolate (Jan. 1, 1995) to the first isolate in a given analysis was counted as the first time interval.

Various EDMs 130 were constructed for data analysis. These EDMs 130 specified the ward(s) and organism(s) involved in a given cluster. The incorporated iterations took three approaches to organism identification: species, single antibiotic result (PAE: ceftazidime; SAU: oxacillin; ENT: vancomycin), and complete antibiogram.

Various values of k, λ, α, β, p0, p1, window size, and probability limits were also incorporated. Separate EDMs 130 were constructed for (a) all isolates, (b) only blood isolates, (c) only sputum/respiratory isolates, (d) only surgical site or tissue isolates. EDMs 130 also defined the independent inclusion and exclusion of data from outside hospitals and cultures for which the indication was outbreak investigation. For each EDM 130, the present invention generated alerts in simulated real-time for all events violating chart control parameters.

Results of all analyses were compiled, and summary parameter sets were defined for EDMs 130, according to the following axes: (a) analysis module, (b) k, λ, α, β, p0, p1, window size, probability limits, (c) specification of specimen type, (d) specification of ward, (e) inclusion of outside cultures, (f) inclusion of non-routine IC surveillance cultures, (g) specification of sub-species resistance (e.g., MRSA rather than S. aureus), and (h) use of Phenotype Grouping Filter. Summary parameter sets were evaluated for sensitivity, and those whose test iterations detected all three clusters were evaluated for positive predictive value, to avoid validating parameter sets with low yield of outbreak detection.

Two definitions of outbreak detection were used. The more strict definition was generation of an alert at the second genotypically identical isolate. The less strict definition was generation of an alert for the month in which the outbreak began. Thus, alerts generated at the second genotypically identical strain were defined as isolate-based true positive results, while alerts generated in the first month of an outbreak were defined as true positive monthly result. Positive predictive value (percent of detected events considered relevant) was calculated in the following manner for those parameter sets that detected both clusters. Klaucke et al., 37 MORB. MORTAL. WEEKLY REP. 1-17 (1988). Possible events detected by test parameter sets which detected at least two of the three outbreaks but which had not been noted by the IC program were evaluated by two hospital epidemiologists, one at the study hospital, the other at a neighboring institution. Monthly counts up to the month of the alarm, organism (PAE, VRE, MRSA), specimen type (blood, sputum, surgical wound, all) and hospital ward were identified. Isolates after the alert were not included to simulate real-life experience. The epidemiologists did not refer to infection control records during evaluation. The epidemiologists classified each event as (A) initiate investigation, (B) monitor, or (C) ignore. A C rating from both epidemiologists or a B from one and a C from the other were considered false positive results; all others were considered true positives.

Event-Interval Analysis Results: A total of 6,384 EDMs 130 were tested, constituting 672 summary parameter sets. A total of 189 EDMs 130 detected the second genotypically identical isolate of the relevant outbreak, while 461 EDMs 130 detected the relevant outbreak month. Four summary parameter sets detected all outbreaks by the isolate metric, while 20 detected all outbreaks by the monthly sensitivity metric.

K-sigma EWMAGC with k=1, 0.2<λ<0.4 were empirically most sensitive, detecting all outbreaks early in their course, with a positive predictive value of 68-100% (mean 72%). PLGC 0.025<λ<0.05 detected only two of three outbreaks.

Detection of Outbreaks: Outbreak 1 was detected by 24 isolate-level parameter sets and 72 month-level parameter sets, including probability limit g-charts. FIG. 2 displays an EWMAGC (k=1, λ=0.4) which detected O1 by the second isolate. Outbreak 2 was detected by 74 isolate-level parameter sets and 156 month-level parameter sets, including probability limit g-charts and k-sigma g-charts with k=1. Outbreak 3 was detected by 53 isolate-level parameter sets and 112 month-level parameter sets, including probability limit g-charts and k-sigma g-charts with k=1.

C-chart Results: C-charts were highly sensitive largely because monthly control limits were seldom greater than 1; thus, any month containing isolates at a node triggered an alert. A total of 912 c-chart EDMs 130 (96 summary parameter sets) were evaluated. Because c-charts do not generate isolate-level alerts, only sensitivity by the monthly metric was evaluated. A total of 442 test iterations (all 96 parameter sets) generated alarms in the first month of the relevant outbreak. Fully 56 (58%) of all parameter sets triggered alerts in the first month of each outbreak. Positive predictive values were over 50%. The c-charts are better suited for detecting large scale changes over long periods of time; on these test data sets of relatively rare events, they were too non-specific.

Moving Average Results: Application of these modules was restricted to the VRE and MRSA outbreaks, as they rely on a resistant antibiotic result for detection, and the Pseudomonas outbreak was caused by a sensitive strain. EDMs 130 were constructed with various window sizes (10, 15, 20, 25, 30, 60) and values of k(1, 2, 3, 4). Both binary and quantitative moving average analyses were performed.

Sensitive MA window sizes varied from 5 (k=4) to 30 (k=1-3) isolates; larger window sizes were insensitive. Mean positive predictive value (PPV) was 11.5% (relaxed criteria)-53.9% (strict criteria). Optimal empirical performance in terms of detecting both outbreaks with maximal PPV was for k=4 and window size of 5-10 isolates (PPV≧10%).

The DWMA analyses, by token of a larger standard deviation, tended to trigger alerts at fewer events. Four parameter sets detected both outbreaks, with window sizes of 15 and 90 and variable values of k Those same four parameter sets were the only to trigger in the outbreak month of both outbreaks, although 184 test iterations triggered an alert at the second isolate of their respective outbreak.

Binary CUSUM Results: Iterations of binary CUSUM were performed with various values for p0 and p1 (0.05, 0.1, 0.15, 0.2), α and β (0.01, 0.05, 0.1, 0.15, 0.2, 0.25), varying the other parameters as in the event interval analyses above. Outbreak 1 was excluded as in moving average analysis above. Of the 11,232 test iterations, 305 detected the second isolate of the relevant outbreak, while 1,843 generated an alarm during the first month of the outbreak. Of the 1,728 summary parameter sets, 56 detected the second isolate of both clusters, while 358 generated an alert during the first month of the outbreak. FIG. 3 demonstrates one such chart, which triggered at the second outbreak isolate.

The EDM 130 architecture has proved capable of rapid evaluation of various analytical methods. Several such methods were capable of detecting the study outbreaks by the second genotypically identical isolate with a high positive predictive value.

### Example 2

We currently have five years (30,000 isolates) of clinical microbiology data from Children's hospital and three years (17,000 isolates) from Beth Israel Deaconess Medical Center.

This Example attempts to discover and catalog a high percentage of the total number of actual outbreaks found in the data. In addition, the present Example uses various techniques to exhaustively characterize the outbreaks by enumerating the specific isolates pertaining to each.

The previously investigated events that have already been discovered, but not exhaustively characterized, are presented in Table 2. Several other techniques are used to discover additional outbreaks in all data sets. Experts exhaustively review the data sets using previously published and validated approaches. Stelling et al., 24(Suppl. 1) CLIN. INFECT. DIS. 157-68 (1997); Boyce et al., 161(3) J. INFECT. DIS. 493-39 (1990); O′Brien et al., Banbury Report 24 (Cold Spring Harbor Laboratory (1987). In addition, the current event detection capabilities of the present invention are used to detect additional potential outbreaks, which are initially validated by the experts, and conclusively validated during the exhaustive characterization. All discovered outbreaks are ranked by estimated size and estimated significance, resulting in an overall interest score.

TABLE 2
Events for initial further characterization

| Hospital | Surveillance Object¹ | Location Type | Year(s) |
|---|---|---|---|
| A | MSSA | Surgery | 1997-1998 |
| A | MRSA | Surgery | 1998 |
| A | Serratia mearcescens | [ICU | 1998 |
| [A | VRE | ICU | 1998 |
| A | VRE | ICU | 1998 |
| A | VRE | Floor | 1998 |
| A | [MSSA | [Floor | 1998 |
| A | MRSA | Surgery | 1998 |
| A | Peudomonas aeruginosa | ICU | 1998 |
| A | Peudomonas aeruginosa | ICU | 1998 |
| A | Serratia marcescens | Surgery | 1999 |
| A | MSSA | Surgery | 1999 |
| B | Aspergillues | [Surgery | 1996 |
| B | Candida parapsilosis | Surgery | 1996-1997 |
| B | Serratia marcescens | [Surgery | 1996 |
| B | Stenotrophomonas | Floor | 1997 |
| | maltophilia | | |
| [B | Enterococcus faecalis | ICU | 1998 |
| B | Enteric GNRs | Floor | 1997 |
| [B | Serriatia marcescens | ICU | 1997 |
| B | Klebsiella pneumonia | ICU | 2000 |
| C | Enterofoccus faecium² | Floor | 1993 |
| [C | MRSA² | Floor | 1992 |
| C | Enterococcus² | Floor | 1986-1988 |
| [C | Staphylococcus epidermidis² | Floor | 2001 |
| D | VRE² | Hematology | 2001 |
| D | MRSA² | ICU | 1998 |
| D | MRSA² | [ICU | 2000 |
| D | VRE² | Surgery | 1996 |

Drawn from infection control documentation and published sources. Boyce et al., 32(5) J. CLIN. MICROBIOL. 1148-53 (1994); Boyce et al., 17(3) CLIN. INFECT. DIS. 496-504 (1993); Boyce et al., 36(5) ANTIMICROB. AGENTS CHEMOTHER. 1032-39 (1992); Boyce et al., 161(3) J. INFECT. DIS. 493-39 (1990).
1 MSSA=methicillin-sensitive S. aureus; MRSA=methicillin-resistant S. aureus; VRE=vancomycin-resistant Enterococcus; GNRs=Gram-negative rods, i.e. E. cloacae, S. marcescens, E. aerogenes, K. pneumoniae, E. coli.
2 Microbial genotyping data available.

After a sufficient number of outbreaks are detected, the outbreaks are fully characterized in order of interest ranking. In collaboration with experts, related isolates are determined using standard epidemiological techniques including genotype, phenotype, temporal sequences, contact history, etc. Each cluster isolate is tagged and numbered in the database as part of that outbreak. Additionally, for each event case definitions are developed and cluster strains likely to be identical are enumerated.

Microbial Taxonomy: In order to improve the power of the analyses, isolates are subdivided into various groups. Sub-groupings may include, but are not limited to, genus, gram-positive bacteria, gram-negative bacteria, enteric gram-negative rods, non lactose-fermenting gram negative rods, and fungi. Experts may assist in the development of this taxonomy and its implementation in the architecture of the present invention, which may include clinical and epidemiological groupings as well. Taxonomic subdivisions comprise additional building blocks for EA-driven EDMs 130.

Write Training Datafiles: When producing the training datafiles for the EAs, the outbreak information is coded into the file headers listing each outbreak, all relevant classification information, and an ordered list of record numbers pertaining to each isolate in the outbreak. This information is critical to obtain a fitness score for each potential outbreak detection technique as well as for determining the success of the Signal Decomposition Based Segmentation.

### Example 3

This Example presents a one year real-time surveillance trial. In preparation for the trial, five years of microbiology data from each hospital is fully characterized: collect and pre-process data, detect a sufficient number of events, exhaustively characterize those events, set up the Linux cluster, and build the EA framework. Those data sets are used by two types of EAs, early detection, and minimal association.

A HIPAA-compliant system is installed at one or more hospitals. In conjunction with experts, a survey is developed and administered to the ICPs at each of the three system sites. The survey attempts to quantify the ICP's ability to detect outbreaks and intervene in a timely manner for the year. The survey is completed by the ICPs both before the start of the system trial, at six months, and at the end. Results from the survey are used to quantify and validate the ability of the system to aid the ICPs in their work.

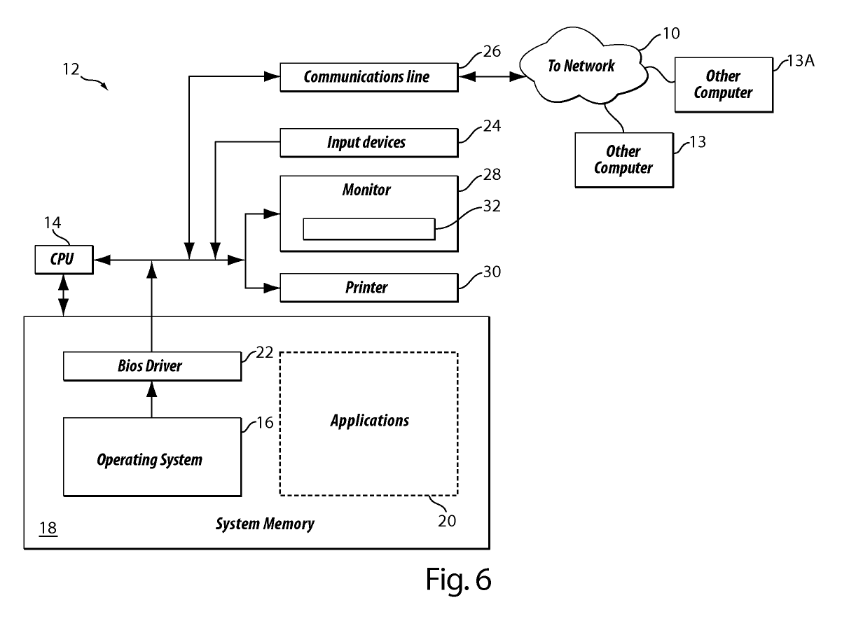

FIG. 6 illustrates the components of a generic computing system connected to a general purpose electronic network 10, such as a computer network. The computer network can be a virtual private network or a public network, such as the Internet. As shown in FIG. 6, the computer system 12 includes a central processing unit (CPU) 14 connected to a system memory 18. The system memory 18 typically contains an operating system 16, a BIOS driver 22, and application programs 20. In addition, the computer system 12 contains input devices 24 such as a mouse or a keyboard 32, and output devices such as a printer 30 and a display monitor 28, and a permanent data store, such as a database 21. The computer system generally includes a communications interface 26, such as an ethernet card, to communicate to the electronic network 10. Other computer systems 13 and 13A also connect to the electronic network 10 which can be implemented as a Wide Area Network (WAN) or as an internetwork, such as the Internet. Data is stored either in many local repositories and synchronized with a central warehouse optimized for queries and for reporting, or is stored centrally in a dual use database.

One skilled in the art would recognize that the foregoing describes a typical computer system connected to an electronic network. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps of the present invention, discussed earlier herein. For example, such a computing system y with multiple processors could be used to implement the EDMs 130 and their various modules described earlier herein.

The present invention also contemplates providing computer readable data storage means with program code recorded thereon (i.e., software) for implementing the method steps described earlier herein. Programming the method steps discussed herein using custom and packaged software is within the abilities of those skilled in the art in view of the teachings herein.

VII Additional Applications using EDMs 130

The Event Detection Machines (EDMs) 130 discussed herein can also be applied to detecting other events of interest in real-time using parallel data flow techniques coupled with control charts (or other event detection analysis techniques discussed herein) to determine if an event is of interest. Therefore, EDMs 130 can be suitably configured as a decision support utility that flags potential events of interest. One of the primary criteria for determining if a process is a good candidate for event detection using suitably configured EDMs 130 is by determining if the process is random with events that occur at regular intervals.

Some of the applications that the event detection techniques using suitably configured EDMs 130 (as discussed herein) may be applied to include, but is not limited to, the following applications:
1) detection of clusters of nosocomial infections that are strong candidates to be an outbreak, these may be detected through statistical process monitoring techniques by, for example, looking for abnormal densities of similar isolates;
(2) detection of emergent trends in the profile of phenotypes, by, for example, measuring the percentage of isolates of one phenotype compared to all phenotypes;
(3) detection of potential performance problems on networks, computer-based or otherwise, by, for example, measuring the volume of network traffic for abnormally high usage;
(4) detection of potential security events on computer networks, by, for example, measuring unusual quantities of login attempts or unusual quantities of packet traffic;
(5) detection of emergent changes to a market's demographic profile, by, for example, measuring volume changes associated with demographics in the market;
(6) detection of the occurrence of potential marketing opportunities in a customer's profile based on detection of certain events, by, for example, measuring sharp changes in a vector generated from a user's profile;
(7) detection of emergent trends in global markets, through, for example, detecting changes in volumetric means;
(8) detection of potential economic events in global markets, through, for example, unusual peaks or valleys in stock or bond prices;
(9) detection of potentially unauthorized activity on a user's account, whether that be a network account, financial account, or other account, through, for example, measuring usage of unusual commands or patterns of commands in the workplace;
(10) detection of emergent trends in any kind of profile by temporal changes in MEP optimization trees; and
(11) detection of the occurrence of events of potential interest in any kind of random process in which events occur at regular intervals through statistical process control (SPC).

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A system for the automatic detection and communication of detection of nosocomial infection and any antimicrobial resistance events in a health care environment comprising:
an input unit that receives nosocomial infection and any antimicrobial resistance related data;
an event detection machine;
a knowledge discovery unit; and
a user interface;
wherein the event detection machine sorts and analyzes the nosocomial infection and any antimicrobial resistance related data to automatically generate alerts for isolates that violate control parameters indicative of a nosocomial infection and any antimicrobial resistance event so that effective antibiotics can be used to properly treat the nosocomial infection;
and wherein the user interface communicates the alerts to a user.

2. The system of claim 1, wherein the received nosocomial infection and any microbial resistance related data is stored in a persistence database which is used by the event detection machine.

3. The system of claim 1, wherein the user interface allows the user to use and interpret analysis results provided by the event detection machine and to define nosocomial infection and any microbial resistance detection parameters.

4. The system of claim 1, wherein the event detection machine comprises:
a plurality of filter banks that filter the received nosocomial infection and any antimicrobial resistance related data based on the control parameters;
a plurality of signal generators that work with the output the filter bank in encoding a data signal with attribute associations based on the control parameters;
a plurality of signal analysis modules which detect nosocomial infection and any antimicrobial resistance events in the data signal; and
a plurality of outputs displaying the results of the event detection.

5. The system of claim 4, wherein the plurality of signal analysis modules comprise implementations of simple control charts, event-interval analysis, moving average analysis, and/or binary cumulative sum analysis.

6. The system of claim 4, such that the plurality of filter banks comprise a phenotype grouping filter that sorts isolates into categories by measuring phenotype instability.

7. The system of claim 6, wherein the phenotype grouping filter is optimized by obtaining a fuzzy logic determination of resistance phenotype sets.

8. The system of claim 4, wherein the plurality of signal generators take an isolate record and convert it into a symbolic representation, generate a sequence using continuous values, or perform calculations using multiple parameters.

9. The system of claim 1, wherein the event detection machine uses simple control analysis, moving average analysis, event-integral analysis, cumulative sum analysis, scan statistics, empty cell analysis, Fourier and Wavelet transforms, and/or least squares regression to analyze the data and generate alerts.

10. The system of claim 4, such that the plurality of signal analysis modules are configured by the knowledge discovery unit that uses evolutionary algorithms to automatically program the event detection machine.

11. The system of claim 10, wherein the event detection machine is configured by implementing the following evolutionary algorithms steps: a generation zero step wherein a zero generation graph is created by randomly connecting analysis modules to the graph; a calculation of fitness step wherein the fitness is calculated iteratively using a fitness function wherein if at any time the fitness drops below a level that would prevent a calculated fitness from achieving a composite score above the mean of the last generation, testing is stopped; and an apply selection, crossover, and mutation step wherein traits are carried forward from one generation to a next generation by deciding which trait has the highest chance of producing a viable solution.

12. The system of claim 11, wherein the apply selection, crossover, and mutation step comprises: a ranking step wherein the solutions are ranked in the order of fitness; an elimination step wherein the solutions are eliminated using a probability of rank divided by population size; a crossover step wherein the empty spots created by the elimination step are filled by the crossover of the remaining solutions; and a mutation step wherein parameter values may be changed or a vertex from the graph may be removed or graph vertex may be changed.

13. The system of claim 4, wherein the knowledge discovery unit comprises statistical process control nodules that monitor for outbreaks caused by a single organism by monitoring for phenotypically similar strains.

14. A method of automatically detecting nosocomial infection and/or microbial resistance events in a healthcare environment comprising the steps of: receiving a nosocomial infection and any antimicrobial resistance related data; developing an event detection machine that automatically sorts and analyzes the nosocomial infection and any antimicrobial related data and automatically generates an alert when an isolate violates control parameters indicative of a nosocomial infection and any microbial resistance; and communicating the generated alert automatically to a user.

15. The method according to claim 14, further comprising storing the received nosocomial infection and any antimicrobial resistance related data in a persistence database which is accessible to the event detection machine.

16. The method according to claim 14, further comprising: providing a plurality of filter banks that filter the received nosocomial infection and any antimicrobial resistance data based on control parameters; providing a plurality of signal generators that work with the output of the filter banks to encode a data signal with attribute associations based on the control parameters; and providing a plurality of signal analysis modules which detect the nosocomial infection and any antimicrobial resistance events in the data signal.

17. The method according to claim 16, further comprising: providing a knowledge discovery unit that uses evolutionary algorithms to configure the signal analysis modules in the event detection machine.

18. A computer readable medium having program code recorded thereon that, when executed on a computing system causes the performance of the steps comprising: receiving a nosocomial infection and any antimicrobial resistance related data; developing an event detection machine that automatically sorts and analyzes the nosocomial infection and any antimicrobial related data and automatically generates an alert when an isolate violates control parameters indicative of a nosocomial infection and any microbial resistance; and communicating the generated alert automatically to a user.

19. The computer readable medium according to claim 18, wherein the program code is further configured to store the received nosocomial infection and any antimicrobial resistance related data in a persistence database which is accessible to the event detection machine.

20. The computer readable medium according to claim 18, wherein the program code is further configured to use evolutionary algorithms in the development of the event detection machine.

21. A method of detecting nosocomial infection and any associated antimicrobial resistance events in a healthcare environment and communicating any antimicrobial confirmation or re-prescription information comprising the steps of:
receiving nosocomial infection and any antimicrobial resistance related data in real-time;
sorting and analyzing the nosocomial infection and any antimicrobial resistance related data;
determining whether one or more nosocomial infections have any antimicrobial resistance data associated therewith;
providing at least one notification with regard to at least one of the patients infected with a particular nosocomial infection that includes information related to the antimicrobial resistance of an antimicrobial currently in use by the at least one patient; and
including with the notification at least one of confirming usage of the current antimicrobial or recommending at least one other antimicrobial for treating the particular nosocomial infection.
